(19) United States
(12) Patent Application Publication
(10) Pub. No.: US 2022/0380663 A1
(43) Pub. Date: Dec. 1, 2022

(54) Enhancement Of Friction Reducer Performance In Hydraulic Fracturing

(71) Applicant: Halliburton Energy Services, Inc., Houston, TX (US)

(72) Inventors: Chunli Li, The Woodlands, TX (US); Leiming Li, Sugar Land, TX (US); Liang Xin Xu, The Woodlands, TX (US); Johnathan Scott Hazlewood, Kingwood, TX (US); James William Ogle, Livingston, TX (US)

(73) Assignee: Halliburton Energy Services, Inc., Houston, TX (US)

(21) Appl. No.: 17/883,113

(22) Filed: Aug. 8, 2022

Related U.S. Application Data
(63) Continuation of application No. 16/890,112, filed on Jun. 2, 2020.

(51) Int. Cl. C09K 8/68; C09K 8/80; E21B 43/267

(52) U.S. Cl. CPC C09K 8/68; C09K 8/80; E21B 43/267; C09K 2208/28

(57) ABSTRACT

A method may include: providing a fracturing fluid including, but not limited to, an aqueous base fluid, a friction reducer, and a friction reduction booster; and introducing the fracturing fluid into the subterranean formation.

### BACKGROUND

Friction reducers are often included as a component of hydraulic fracturing fluids to impart desirable properties to the hydraulic fracturing fluid. Pumping rates for hydraulic fracturing operations may regularly exceed 50 barrels per minute (8 m³/min) or more, which may cause turbulence in conduits such as wellbore tubing, liners, and casings. Turbulent flow of hydraulic fracturing fluids leads to high horsepower requirements to maintain pressure and flow rates. Some common friction reducers may include long chain water soluble polymers which may aid in moderating turbulence by reducing eddy currents within a conduit.

A friction reducer may be selected to be included in a fracturing fluid based at least in part on chemical properties of aqueous base fluids available to mix the fracturing fluid at a well site. The properties of aqueous base fluids such as total dissolved solids, pH, and temperature may affect the performance of the friction reducer. Dissolved solids may associate with the friction reducer which may reduce the performance of the friction. A loss of performance of a friction reducer may lead to a reduction in the viscosity of the fracturing fluid and may increase the horsepower required to maintain flow rates. The loss in performance may further lead to less efficient movement of proppant particles in the fracturing fluid and may restrict flow across the perforations in the wellbore and restrict flow through fractures generated in the subterranean formation.

### BRIEF DESCRIPTION OF THE DRAWINGS

These drawings illustrate certain aspects of the present disclosure and should not be used to limit or define the disclosure.

FIG. 1 is a schematic view of an example well system utilized for hydraulic reducer.

FIG. 2 is a schematic view of an example of a wellbore after introduction of fracturing fluid.

FIG. 3 is a graph of results of a flow loop test.

FIG. 4 is a graph of results of a flow loop test.

FIG. 5 is a graph of results of a flow loop test.

FIG. 6 is a graph of results of a flow loop test.

FIG. 7 is a graph of results of a flow loop test.

FIG. 8 is a graph of results of a flow loop test.

FIG. 9 is a graph of results of a flow loop test.

FIG. 10 is a graph of results of a viscosity test.

### DETAILED DESCRIPTION

The present disclosure may relate to subterranean operations, and, in one or more implementations, to hydraulic fracturing methods and methods of improving performance of friction reducers included in hydraulic fracturing fluids. Fracturing fluids may include friction reducers and friction reduction boosters in an aqueous base fluid. As discussed above, aqueous base fluids may contain dissolved species which may interfere with the performance of friction reducers. Friction reduction boosters may improve the performance of the friction reducers by at least partially counteracting the effects of the dissolved species.

Friction reducers may be long chain water soluble polymers which when added to water have the property of reducing friction in the fluids they are added to. Friction reducers may decrease the amount of power required to move a fracturing fluid through a conduit and subterranean formation by modifying the fluid characteristics by changing the flow of the fluid from turbulent to laminar. In addition to reducing power requirements, friction reducers may aid in transport of solids, such as proppants, by providing viscosity to the hydraulic fracturing fluid. Some commonly used friction reducers may include polyacrylamide-containing polymers, however there may be a wide range of friction reducer chemistries which are suitable for inclusion in hydraulic fracturing fluids. Friction reducers may be provided as invert emulsions with the friction reducer being stored in water droplets dispersed in a continuous oil phase. Friction reducers provided as invert emulsion may require inversion of the emulsion to form a water external emulsion such that the friction reducer droplets may be exposed to the bulk aqueous fluid. One challenge of using friction reducers in aqueous fluids with dissolved solids is that the dissolved solids may be electrically attracted to and associate with the friction reducer which may result in a reduction of performance and a reduction in fluid viscosity. The loss of friction reducer performance may lead to high power requirements and poor solids transport.

High viscosity friction reducers may be included in hydraulic fracturing fluids. High viscosity friction reducers (HVFR) may provide beneficial results to the performance of fracturing fluids. HVFRs may be long chain polyacrylamide-containing polymers which may provide increased viscosity over relatively shorter chain length polyacrylamide-containing polymers. Inclusion of HVFRs in fracturing fluids may lower operational costs, increase regain conductivities, increase solids transport, and may create higher complexities in fracture creation. Although high viscosity friction reducers may provide benefits to the fracturing fluid, the performance of the high viscosity friction reducer may be affected by its compatibility with the water or aqueous based fluid. In aqueous base fluids with dissolved solids, the high viscosity friction reducers may show a decrease in fluid performance and a loss in viscosity as compared to fluids which do not contain dissolved solids. The losses in viscosity may, in part, lead to the inefficient transport of the proppant and other solids in the fracturing fluid throughout the wellbore, the perforations, and the formation.

Friction reducers may be anionic, cationic, non-ionic, or zwitterionic depending on the monomers used to synthesize the friction reducer. Friction reducers may be synthesized from a variety of monomeric units, including, but not limited to, acrylamide, acrylic acid, 2-acrylamido-2-methylpropane sulfonic acid, acrylamido tertiary butyl sulfonic acid, N,N-dimethylacrylamide, vinyl sulfonic acid, N-vinyl acetamide, N-vinyl formamide, itaconic acid, methacrylic acid, acrylic acid esters, methacrylic acid esters and combinations thereof. Others friction reducers may include, but not limited to, a polyacrylamide, a polyacrylamide derivative, a synthetic polymer, an acrylamide copolymer, an anionic acrylamide copolymer, a cationic acrylamide copolymer, a nonionic acrylamide copolymer, an amphoteric acrylamide copolymer, a polyacrylate, a polyacrylate derivative, a polymethacrylate, a polymethacrylate derivative, and combinations thereof. Friction reducers may be in an acid form or in a salt form. As will be a variety of salts may be prepared, for example, by neutralizing the acid form of the acrylic acid monomer or the 2-acrylamido-2-methylpropane sulfonic acid monomer. In addition, the acid form of the polymer may be neutralized by ions present in the fracturing fluid.

The friction reducer may be included in the hydraulic fracturing fluid in any suitable amount, including from about 0.1 gallons of the friction reducer per thousand gallons of the fracturing fluid (“gpt”) to about 4 gpt or more. Alternatively, the friction reducer may be included in an amount ranging from about 0.1 gpt to about 0.5 gpt, amount ranging from about 0.5 gpt to about 1 gpt, an amount ranging from about 1 gpt to about 2 gpt, an amount ranging from about 2 gpt to about 3 gpt, amount ranging from about 3 gpt to about 5 gpt, an amount ranging from about 1 gpt to about 10 gpt, or alternatively, an amount ranging between any of the previously recited ranges. When provided as a liquid additive, the friction reducer may be in the form of an emulsion, a liquid concentrate, and a slurry. The friction reducer may also be provided as a dry additive and may be present in an amount ranging from about 0.01% wt. % to about 0.5 wt. % or more based on a total weight of the hydraulic fracturing fluid. Alternatively an amount ranging from about 0.01 wt. % to about 0.025 wt. %, an amount ranging from about 0.025 wt. % to about to about 0.04 wt. %, an amount ranging from about 0.04 wt. % to about 0.06 wt. %, an amount ranging from about 0.06 wt. % to about 0.09 wt. %, an amount ranging from about 0.09 wt. % to about 0.12 wt. %, an amount ranging from about 0.12 wt. % to about 0.15 wt. %, an amount ranging from about 0.15 wt. % to about 0.2 wt. %, an amount ranging from about 0.2 wt. % to about 0.25 wt. %, an amount ranging from about 0.25 wt. % to about 0.3 wt. %, an amount ranging from about 0.3 wt. % to about 0.35 wt. %, an amount ranging from about 0.35 wt. % to about 0.4 wt. %, an amount ranging from about 0.45 wt. % to about 0.5 wt. %, or alternatively, an amount ranging between any of the previously recited ranges.

The aqueous based fluid may include fresh water, produced water, salt water, surface water, or any other suitable water. The term “salt water” is used herein to mean unsaturated salt solutions and saturated salt solutions including brines and seawater. The aqueous base fluid may include dissolved species of salts and metals that make up the total dissolved solids count for a particular sample of aqueous base fluid. The dissolved solids may include, but are not limited to chlorides, sulfates, bicarbonates, magnesium, calcium, strontium, potassium, sodium, and combinations thereof. Examples of dissolved solids may further include, but are not limited to, lithium, beryllium, magnesium, calcium, strontium, iron, zinc, manganese, molybdenum, sulfur in the form of hydrogen sulfide, arsenic, barium, boron, chromium, selenium, uranium, fluorine, bromine, iodine, and combinations thereof. The concentration of dissolved solids may vary depending on the source of the aqueous based fluid. For example, without limitation, the total dissolved solids may be present at a point ranging from about 3,000 TDS to about 250,000 TDS based on the total weight of the hydraulic fracturing fluid. Alternatively, at a point ranging from about 3,000 TDS to about 10,000 TDS, at a point ranging from about 10,000 TDS to about 20,000 TDS, at a point ranging from about 20,000 TDS to about 30,000 TDS, at a point ranging from about 30,000 TDS to about 40,000 TDS, at a point ranging from about 40,000 TDS to about 50,000 TDS, at a point ranging from about 50,000 TDS to about 60,000 TDS, or a point ranging from about 60,000 TDS to about 70,000 TDS. One of ordinary skill in the art with the benefit of this disclosure should be able to identify the TDS of the water or aqueous fluid appropriate for a particular hydraulic fracturing fluid. The term “high” in the context of high total dissolved solids or high TDS, may be intended to refer to an aqueous base fluid having a TDS of greater than 20,000 TDS.

Dissolved solids may impact the functionality of the hydraulic fracturing fluid by decreasing the viscosity of the friction reducer and the friction reduction performance. The reduction in viscosity and performance may be dependent upon the concentration of dissolved solids where a higher TDS generally correlates to worse performance and lower viscosity. Inclusion of a friction reducer booster in a fracturing fluid may at least partially mitigate the effects of the dissolved solids on the friction reducer. In some examples, the friction reducer booster may include a quaternary amine. The quaternary amine may improve the friction reduction performance of anionic, cationic, and nonionic friction reducers. Surprisingly, a positively charged quaternary amine may improve the performance of anionic friction reducers. As discussed above, dissolved cationic species may be expected to interfere with anionic friction reducers, however, quaternary amines show compatibility with anionic friction reducers and boost friction reducer performance.

Friction reduction boosters may have the general chemical structure of the quaternary amine is depicted in Structure 1. The R1, R2, R3, and R4 groups may be individually selected from C1-C24 alkyl and aryl. The C1-C24 alkyl group may have the general formula CₙH₂ₙ₊₁, where “n” may be any whole integer from 1 to 24.

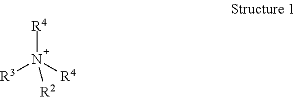

An exemplary friction reduction booster is illustrated in Structure 2. In Structure 2, n may be any even integer from 8 to 20 and X may be any halide. For example, without limitation, n may be 8, 10, 12, 14, 16, or 18 and X may be Cl. In some examples, the friction reduction booster may be a mixture of the friction reduction booster of Structure 2 with varying numbers for n.

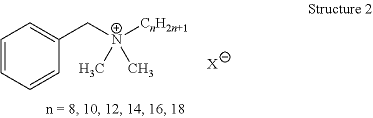

Another exemplary friction reduction booster is illustrated in Structure 3. In structure 3, X may be any halide, including Cl.

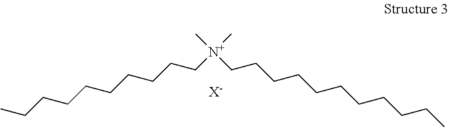

Some specific examples of the friction reducer booster may include, but are not limited to, alkyldimethylbenzylammonium chloride (ADBAC), and dodecyledimethylammonium chloride (DDAC). The friction reducer booster may be included in any amount in the fracturing fluid. Without limitation, the friction reducer booster may be present at a point ranging from about 0.007 gpt to about 2 gpt. Alternatively, at a point ranging from about 0.0075 gpt to about 0.03 gpt, at a point ranging from about 0.03 gpt to about 0.1 gpt, at a point ranging from about 0.1 gpt to about 0.3 gpt, at a point ranging from about 0.3 gpt to about 0.5 gpt, at a point ranging from about 0.5 gpt to about 1 gpt, or at a point ranging from about 1 gpt to about 2 gpt.

A hydraulic fracturing fluid may include an aqueous base fluid, friction reducer, and a friction reducer booster. In some examples, the hydraulic fracturing fluid may include a proppant. Water used in oilfield operations may be from various sources including surface water such as from lakes, rivers, estuaries, and oceans for example, as well as ground water from aquifers and water wells. One additional source of water in the oilfield may be produced water such as water that flows from a hydrocarbon well. Hydrocarbon wells often penetrate subterranean formations that contain a fraction of water alongside hydrocarbons. As such, fluids that are produced from a hydrocarbon well may contain hydrocarbons as well as a fraction of water. The produced fluids may be separated at the surface to generate a hydrocarbon stream and a water stream. The water stream may be further utilized to mix treatment fluids for well treatment such as drilling, cementing, stimulation, and enhanced recovery operations. The separated water stream may be referred to as produced water.

During preparation of treatment fluids, freshwater may be used as a base fluid with additional “make up” water used to make up the remaining volume of fluid required for a particular application. Make up water may be from any source as described above including surface water, ground water, and produced water, for example. Each of the sources of water may have varying levels of species dissolved therein, including those species previously described, which may affect the stability of friction reducers added to the water. The water or aqueous based fluid may be present in any amount by weight suitable for a particular hydraulic fracturing application. For example, without limitation, the water may be present at a point ranging from about 0 wt. % to about 100 wt. % based on a total weight of the hydraulic fracturing fluid. Alternatively, at a point ranging from about 50 wt. % to about 60 wt. %, at a point ranging from about 60 wt. % to about 70 wt. %, at a point ranging from about 70 wt. % to about 80 wt. %, at a point ranging from about 80 wt. % to about 90 wt. %, or at a point ranging from about 90 wt. % to about 100 wt. %. One of ordinary skill in the art with the benefit of this disclosure should be able to select an appropriate weight percent of water for a particular hydraulic fracturing fluid.

A hydraulic fracturing fluid may include proppants. Proppants may include a collection of solid particles that may be pumped into the subterranean formation, such that the solid particles hold (or “prop”) open the fractures generated during a hydraulic fracturing treatment. The proppant may include a variety of solid particles, including, but not limited to, sand, bauxite, ceramic materials, glass materials, polymer materials, polytetrafluoroethylene materials, nut shell pieces, cured resinous particulates including nut shell pieces, seed shell pieces, cured resinous particulates including seed shell pieces, fruit pit pieces, cured resinous particulates including fruit pit pieces, wood, composite particulates, and combinations thereof. Suitable composite particulates may include a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The proppant may have any suitable particle size for a particular application such as, without limitation, nano particle size, micron particle size, or any combinations thereof. As used herein, the term particle size refers to a d50 particle size distribution, wherein the d50 particle size distribution is the value of the particle diameter at 50% in the cumulative distribution. The d50 particle size distribution may be measured by particle size analyzers such as those manufactured by Malvern Instruments, Worcestershire, United Kingdom. As used herein, nano-size is understood to mean any proppant with a d50 particle size distribution of less than 1 micron. For example, a proppant with a d50 particle size distribution at point ranging from about 10 nanometers to about 1 micron. Alternatively, a proppant with a d50 particle size distribution at point ranging from about 10 nanometers to about 100 nanometers, a proppant with a d50 particle size distribution at point ranging from about 100 nanometers to about 300 nanometers, a proppant with a d50 particle size distribution at point ranging from about 300 nanometers to about 700 nanometers, a proppant with a d50 particle size distribution at point ranging from about 700 nanometers to about 1 micron, or a proppant with a d50 particle size distribution between any of the previously recited ranges. As used herein, micron-size is understood to mean any proppant with a d50 particle size distribution at a point ranging from about 1 micron to about 1000 microns. Alternatively, a proppant with a d50 particle size distribution at point ranging from about 1 micron to about 100 microns, a proppant with a d50 particle size distribution at point ranging from about 100 microns to about 300 microns, a proppant with a d50 particle size distribution at point ranging from about 300 microns to about 700 micron, a proppant with a d50 particle size distribution at point ranging from about 700 microns to about 1000 microns, or a proppant with a d50 particle size distribution between any of the previously recited ranges.

Alternatively, proppant particle sizes may be expressed in U.S. mesh sizes such as, for example, 20/40 mesh (212 μm-420 μm). Proppants expressed in U.S. mesh sizes may include proppants with particle sizes at a point ranging from about 8 mesh to about 140 mesh (106 μm-2.36 mm). Alternatively a point ranging from about 16-30 mesh (600 μm-1180 μm), a point ranging from about 20-40 mesh (420 μm-840 μm), a point ranging from about 30-50 mesh (300 μm-600 μm), a point ranging from about 40-70 mesh (212 μm-420 μm), a point ranging from about 70-140 mesh (106 μm-212 μm), or alternatively any range there between. The standards and procedures for measuring a particle size or particle size distribution may be found in ISO 13503, or, alternatively in API RP 56, API RP 58, API RP 60, or any combinations thereof.

Proppants may include any suitable density. In some examples, proppants may have a density at a point ranging from about 1.25 g/cm³ to about 10 g/cm³. Proppants may include any shape, including but not limited, to spherical, toroidal, amorphous, planar, cubic, or cylindrical. Proppants may further include any roundness and sphericity. Proppant may be present in the fracturing fluid in any concentration or loading. Without limitation, the proppant may be present a point ranging from about 0.1 pounds per gallon (“lb/gal”) (12 kg/m³) to about 14 lb/gal (1677 kg/m³). Alternatively, a point ranging from about 0.1 lb/gal (12 kg/m³) to about 1 lb/gal (119.8 kg/m³), a point ranging from about 1 lb/gal (119.8 kg/m³) to about 3 lb/gal (359.4 kg/m³), a point ranging from about 3 lb/gal (359.4 kg/m³) to about 6 lb/gal (718.8 kg/m³), a point ranging from about 6 lb/gal (718.8 kg/m³) to about 9 lb/gal (1078.2 kg/m³), a point ranging from about 9 lb/gal (1078.2 kg/m³) to about 12 lb/gal (1437.6 kg/m³), a point ranging from about 12 lb/gal (1437.6 kg/m³) to about 14 lb/gal (1677.2 kg/m³), or alternatively, any range therebetween.

Gelling agents may be included in the hydraulic fracturing fluid to increase the hydraulic fracturing fluid's viscosity which may be desired for some types of subterranean applications. For example, an increase in viscosity may be used for transferring hydraulic pressure to divert treatment fluids to another part of a formation or for preventing undesired leak-off of fluids into a formation from the buildup of filter cakes. The increased viscosity of the gelled or gelled and cross-linked treatment fluid, among other things, may reduce fluid loss and may allow the fracturing fluid to transport significant quantities of suspended proppant. Gelling agents may include, but are not limited to, any suitable hydratable polymer, including, but not limited to, galactomannan gums, cellulose derivatives, combinations thereof, derivatives thereof, and the like. Galactomannan gums are generally characterized as having a linear mannan backbone with various amounts of galactose units attached thereto. Examples of suitable galactomannan gums include, but are not limited to, gum arabic, gum ghatti, gum karaya, tamarind gum, tragacanth gum, guar gum, locust bean gum, combinations thereof, derivatives thereof, and the like. Other suitable gums include, but are not limited to, hydroxyethylguar, hydroxypropylguar, carboxymethylguar, carboxymethylhydroxyethylguar and carboxymethylhydroxypropylguar. Examples of suitable cellulose derivatives include hydroxyethyl cellulose, carboxyethylcellulose, carboxymethylcellulose, and carboxymethylhydroxyethylcellulose; derivatives thereof, and combinations thereof. The crosslinkable polymers included in the treatment fluids of the present disclosure may be naturally-occurring, synthetic, or a combination thereof. The crosslinkable polymers may include hydratable polymers that contain one or more functional groups such as hydroxyl, cis-hydroxyl, carboxyl, sulfate, sulfonate, phosphate, phosphonate, amino, or amide groups. In certain systems and/or methods, the crosslinkable polymers may be at least partially crosslinked, wherein at least a portion of the molecules of the crosslinkable polymers are crosslinked by a reaction including a crosslinking agent. The gelling agent may be present in the fracturing fluid in an amount ranging from about 0.5 lbs/1,000 gal of hydraulic fracturing fluid (0.05991 kg/m\hat{ }3) to about 200 lbs/1,000 gal (23.946 kg/m\hat{ }3). Alternatively, in an amount ranging from about 5 lbs/1,000 gal (0.5991 kg/m\hat{ }3) to about 10 lbs/1,000 gal (1.198 kg/m\hat{ }3), in an amount ranging from about 10 lbs/1,000 gal (1.198 kg/m\hat{ }3) to about 15 lb/1,000 gal (1.797 kg/m\hat{ }3), in an amount ranging from about 15 lb/1,000 gal (1.797 kg/m\hat{ }3) to about 20 lb/1,000 gal (2.3946 kg/m\hat{ }3), or alternatively, an amount ranging between any of the previously recited ranges.

The hydraulic fracturing fluid may include any number of additional optional additives, including, but not limited to, salts, acids, fluid loss control additives, gas, foamers, corrosion inhibitors, scale inhibitors, catalysts, clay control agents, biocides, friction reducers, iron control agent, antifoam agents, bridging agents, dispersants, hydrogen sulfide (“H₂S”) scavengers, carbon dioxide (“CO₂”) scavengers, oxygen scavengers, lubricants, viscosifiers, breakers, weighting agents, inert solids, emulsifiers, emulsion thinner, emulsion thickener, surfactants, lost circulation additives, pH control additive, buffers, crosslinkers, stabilizers, chelating agents, mutual solvent, oxidizers, reducers, consolidating agent, complexing agent, sequestration agent, control agent, particulate materials and any combination thereof. With the benefit of this disclosure, one of ordinary skill in the art should be able to recognize and select a suitable optional additive for use in the fracturing fluid.

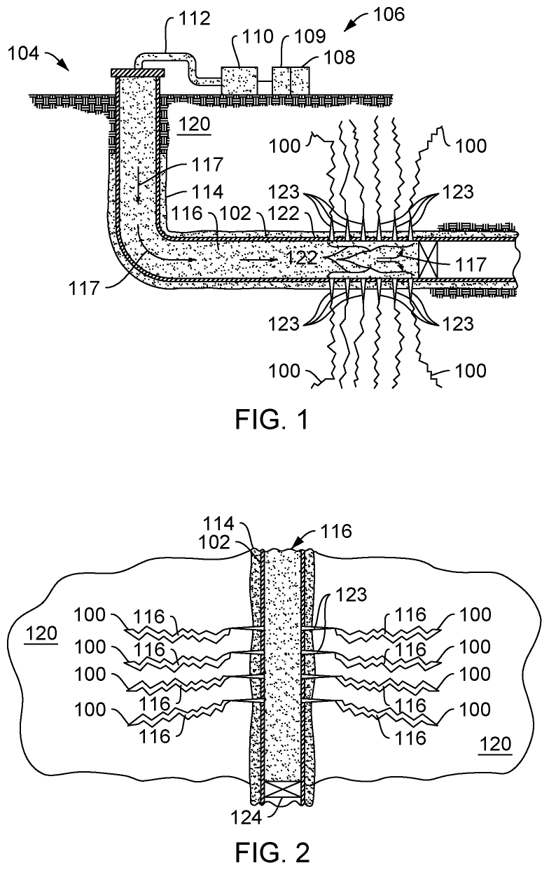

FIG. 1 illustrates an example of a well system 104 that may be used to introduce proppant 116 into fractures 100. Well system 104 may include a fluid handling system 106, which may include fluid supply 108, mixing equipment 109, pumping equipment 110, and wellbore supply conduit 112. Pumping equipment 110 may be fluidly coupled with the fluid supply 108 and wellbore supply conduit 112 to communicate a fracturing fluid 117, which may include proppant 116 into wellbore 114. Proppant 116 may be any of the proppants described herein. The fluid supply 108 and pumping equipment 110 may be above the surface 118 while the wellbore 114 is below the surface 118.

Well system 104 may also be used for the pumping of a pad or pre-pad fluid into the subterranean formation at a pumping rate and pressure at or above the fracture gradient of the subterranean formation to create and maintain at least one fracture 100 in subterranean formation 120. The pad or pre-pad fluid may be substantially free of solid particles such as proppant, for example, less than 1 wt. % by weight of the pad or pre-pad fluid. Well system 104 may then pump the fracturing fluid 117 into subterranean formation 120 surrounding the wellbore 114, Generally, a wellbore 114 may include horizontal, vertical, slanted, curved, and other types of wellbore geometries and orientations, and the proppant 116 may generally be applied to subterranean formation 120 surrounding any portion of wellbore 114, including fractures 100. The wellbore 114 may include the casing 102 that may be cemented (or otherwise secured) to the wall of the well bore 114 by cement sheath 122. Perforations 123 may allow communication between the wellbore 114 and the subterranean formation 120. As illustrated, perforations 123 may penetrate casing 102 and cement sheath 122 allowing communication between interior of casing 102 and fractures 100. A plug 124, which may be any type of plug for oilfield applications (e.g., bridge plug), may be disposed in wellbore 114 below the perforations 123.

In accordance with systems and/or methods of the present disclosure, a perforated interval of interest 130 (depth interval of wellbore 114 including perforations 123) may be isolated with plug 124. A pad or pre-pad fluid may be pumped into the subterranean formation 120 at a pumping rate and pressure at or above the fracture gradient to create and maintain at least one fracture 100 in subterranean formation 120. Then, proppant 116 may be mixed with an aqueous based fluid via mixing equipment 109, thereby forming a fracturing fluid 117, and then may be pumped via pumping equipment 110 from fluid supply 108 down the interior of casing 102 and into subterranean formation 120 at or above a fracture gradient of the subterranean formation 120. Pumping the fracturing fluid 117 at or above the fracture gradient of the subterranean formation 120 may create (or enhance) at least one fracture (e.g., fractures 100) extending from the perforations 123 into the subterranean formation 120. Alternatively, the fracturing fluid 117 may be pumped down production tubing, coiled tubing, or a combination of coiled tubing and annulus between the coiled tubing and the casing 102.

At least a portion of the fracturing fluid 117 may enter the fractures 100 of subterranean formation 120 surrounding wellbore 114 by way of perforations 123. Perforations 123 may extend from the interior of casing 102, through cement sheath 122, and into subterranean formation 120.

Referring to FIG. 1, the wellbore 114 is shown after placement of the proppant 116 in accordance with systems and/or methods of the present disclosure. Proppant 116 may be positioned within fractures 100, thereby propping open fractures 100.

The pumping equipment 110 may include a high pressure pump. As used herein, the term “high pressure pump” refers to a pump that is capable of delivering the fracturing fluid 117 and/or pad/pre-pad fluid downhole at a pressure of about 1000 psi (6894 kPa) or greater. A high pressure pump may be used when it is desired to introduce the fracturing fluid 117 and/or pad/pre-pad fluid into subterranean formation 120 at or above a fracture gradient of the subterranean formation 120, but it may also be used in cases where fracturing is not desired. Additionally, the high pressure pump may be capable of fluidly conveying particulate matter, such as the proppant 116, into the subterranean formation 120. Suitable high pressure pumps may include, but are not limited to, floating piston pumps and positive displacement pumps. Without limitation, the initial pumping rates of the pad fluid, pre-pad fluid and/or fracturing fluid 117 may range from about 15 barrels per minute (“bbl/min”) (2385 l/min) to about 80 bbl/min (12719 l/min), enough to effectively create a fracture into the formation and place the proppant 116 into at least one fracture 101.

Alternatively, the pumping equipment 110 may include a low pressure pump. As used herein, the term “low pressure pump” refers to a pump that operates at a pressure of about 1000 psi (6894 kPa) or less. A low pressure pump may be fluidly coupled to a high pressure pump that may be fluidly coupled to a tubular (e.g., wellbore supply conduit 112). The low pressure pump may be configured to convey the fracturing fluid 117 and/or pad/pre-pad fluid to the high pressure pump. The low pressure pump may “step up” the pressure of the fracturing fluid 117 and/or pad/pre-pad fluid before it reaches the high pressure pump.

Mixing equipment 109 may include a mixing tank that is upstream of the pumping equipment 110 and in which the fracturing fluid 117 may be formulated. The pumping equipment 110 (e.g., a low pressure pump, a high pressure pump, or a combination thereof) may convey fracturing fluid 117 from the mixing equipment 109 or other source of the fracturing fluid 117 to the casing 102. Alternatively, the fracturing fluid 117 may be formulated offsite and transported to a worksite, in which case the fracturing fluid 117 may be introduced to the casing 102 via the pumping equipment 110 directly from its shipping container (e.g., a truck, a railcar, a barge, or the like) or from a transport pipeline. In either case, the fracturing fluid 117 may be drawn into the pumping equipment 110, elevated to an appropriate pressure, and then introduced into the casing 102 for delivery downhole.

A hydraulic fracturing operation may operate in stages where a bridge plug, frac plug, or other obstruction is inserted into the wellbore to prevent fluid communication with a region of the wellbore after the bridge plug. A perforating gun including explosive shaped charges may be inserted into a region of the wellbore before the bridge plug (i.e. a region where the measured depth is less than the measured depth of the bridge plug) and perforate holes through the walls of the wellbore. The perforating gun may be removed from the wellbore and a fracturing fluid introduced thereafter. The stage is completed when the planned volume of fluid and proppant has been introduced into the subterranean formation. Another stage may begin with the insertion of a second bridge plug into a wellbore region before the bridge plug.

The exemplary treatment fluids disclosed herein may directly or indirectly affect one or more components or pieces of equipment associated with the preparation, delivery, recapture, recycling, reuse, and/or disposal of the disclosed treatment fluids. For example, the disclosed treatment fluids may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the exemplary treatment fluids. The disclosed treatment fluids may also directly or indirectly affect any transport or delivery equipment used to convey the treatment fluids to a well site or downhole such as, for example, any transport vessels, conduits, pipelines, trucks, tubulars, and/or pipes used to compositionally move the treatment fluids from one location to another, any pumps, compressors, or motors (e.g., topside or downhole) used to drive the treatment fluids into motion, any valves or related joints used to regulate the pressure or flow rate of the treatment fluids, and any sensors (i.e., pressure and temperature), gauges, and/or combinations thereof, and the like. The disclosed treatment fluids may also directly or indirectly affect the various downhole equipment and tools that may come into contact with the treatment fluids such as, but not limited to, wellbore casing, wellbore liner, completion string, insert strings, drill string, coiled tubing, slick line, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydro mechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Accordingly, the present disclosure may provide methods relating to preparation of fracturing fluids. The methods may include any of the various features disclosed herein, including one or more of the following statements.

Statement 1. A method of fracturing a subterranean formation comprising: providing a fracturing fluid comprising: an aqueous base fluid, a friction reducer, and a friction reduction booster; and introducing the fracturing fluid into the subterranean formation.

Statement 2. The method of statement 1, wherein the aqueous base fluid has a concentration of total dissolved solids of about 3,000 TDS to about 250,000 TDS.

Statement 3. The methods of any of statements 1-2, wherein the total dissolved solids comprise at least one of chlorides, sulfates, bicarbonates, magnesium, calcium, strontium, potassium, sodium, lithium, beryllium, magnesium, calcium, strontium, iron, zinc, manganese, molybdenum, sulfur in a form of hydrogen sulfide, arsenic, barium, boron, chromium, selenium, uranium, fluorine, bromine, iodine, and combinations thereof.

Statement 4. The methods of any of statements 1-3, wherein the friction reducer is selected from the group consisting of at least one of a polyacrylamide, a polyacrylamide derivative, a synthetic polymer, an acrylamide copolymer, an anionic acrylamide copolymer, a cationic acrylamide copolymer, a nonionic acrylamide copolymer, an amphoteric acrylamide copolymer, a polyacrylate, a polyacrylate derivative, a polymethacrylate, a polymethacrylate derivative, polymers synthesized from one or more monomeric units selected from the group consisting of acrylamide, acrylic acid, 2-acrylamido-2-methylpropane sulfonic acid, acrylamido tertiary butyl sulfonic acid, N,N-dimethylacrylamide, vinyl sulfonic acid, N-vinyl acetamide, N-vinyl formamide, itaconic acid, methacrylic acid, acrylic acid esters, or methacrylic acid esters, their corresponding salts related salts, their corresponding esters, or combinations thereof.

Statement 5. The method of any of statements 1-4, wherein the friction reduction booster comprises a quaternary amine with the following structure:

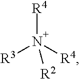

wherein R1, R2, R3, and R4 are individually selected from C1-C24 alkyl and aryl.

Statement 6. The method of any of statements 1-5, wherein the quaternary amine has the following structure:

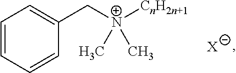

where n is any even integer from 8 to 20 and x is a halide.

Statement 7. The method of any of statements 1-6, wherein the quaternary amine has the following structure:

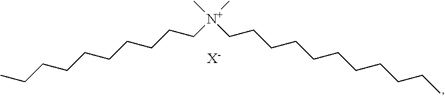

where x is a halide.

Statement 8. The method of any of statements 1-7, wherein the friction reduction booster is present in a range of about 0.007 gpt to about 0.03 gpt.

Statement 9. The method of any of statements 1-8, wherein the friction reducer is present in a range of about 1 gpt to about 10 gpt.

Statement 10. The method of any of statements 1-9, wherein the fracturing fluid further comprises a proppant.

Statement 11. A fracturing fluid comprising: an aqueous base fluid; a friction reducer; and a friction reduction booster.

Statement 12. The fracturing fluid of statement 11, wherein the aqueous base fluid has a concentration of total dissolved solids of about 3,000 TDS to about 250,000 TDS.

Statement 13: The fracturing fluid of any of statements 11-12, wherein the friction reducer is selected from the group consisting of at least one of a polyacrylamide, a polyacrylamide derivative, a synthetic polymer, an acrylamide copolymer, an anionic acrylamide copolymer, a cationic acrylamide copolymer, a nonionic acrylamide copolymer, an amphoteric acrylamide copolymer, a polyacrylate, a polyacrylate derivative, a polymethacrylate, a polymethacrylate derivative, polymers synthesized from one or more monomeric units selected from the group consisting of acrylamide, acrylic acid, 2-acrylamido-2-methylpropane sulfonic acid, acrylamido tertiary butyl sulfonic acid, N,N-dimethylacrylamide, vinyl sulfonic acid, N-vinyl acetamide, N-vinyl formamide, itaconic acid, methacrylic acid, acrylic acid esters, or methacrylic acid esters, their corresponding salts related salts, their corresponding esters, or combinations thereof.

Statement 14. The fracturing fluid of any of statements 11-13, wherein the friction reduction booster comprises a quaternary amine with the following structure:

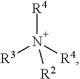

where R1, R2, R3, and R4 are individually selected from C1-C24 alkyl and aryl

Statement 15. The fracturing fluid of any of statements 11-14, wherein the quaternary amine has the following structure:

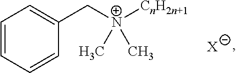

where n is any even integer from 8 to 20 and X is a halide.

Statement 16. The fracturing fluid of any of statements 11-15, wherein the quaternary amine has the following structure:

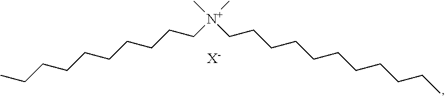

where x is a halide.

Statement 17. The fracturing fluid of any of statements 11-16, wherein the friction reduction booster is present in a range of about 0.007 gpt to about 0.03 gpt.

Statement 18. The fracturing fluid of any of statements 11-17, wherein the friction reducer is present in a range of about 1 gpt to about 10 gpt.

Statement 19. The fracturing fluid of any of statements 11-18, wherein the fracturing fluid further comprises a proppant.

Statement 20. A method of fracturing a subterranean formation comprising: providing a fracturing fluid comprising: an aqueous base fluid, wherein the aqueous base fluid is water with a concentration of total dissolved solids of about 3,000 TDS to about 250,000 TDS, a friction reducer, wherein the friction reducer is a polyacrylamide-containing polymer present in an amount of about 1 gpt to about 10 gpt, and a friction reduction booster, wherein the friction reduction booster is DDAC present in an amount of about 0.007 gpt to about 0.03 gpt; and introducing the fracturing fluid into the subterranean formation.

### Example 1

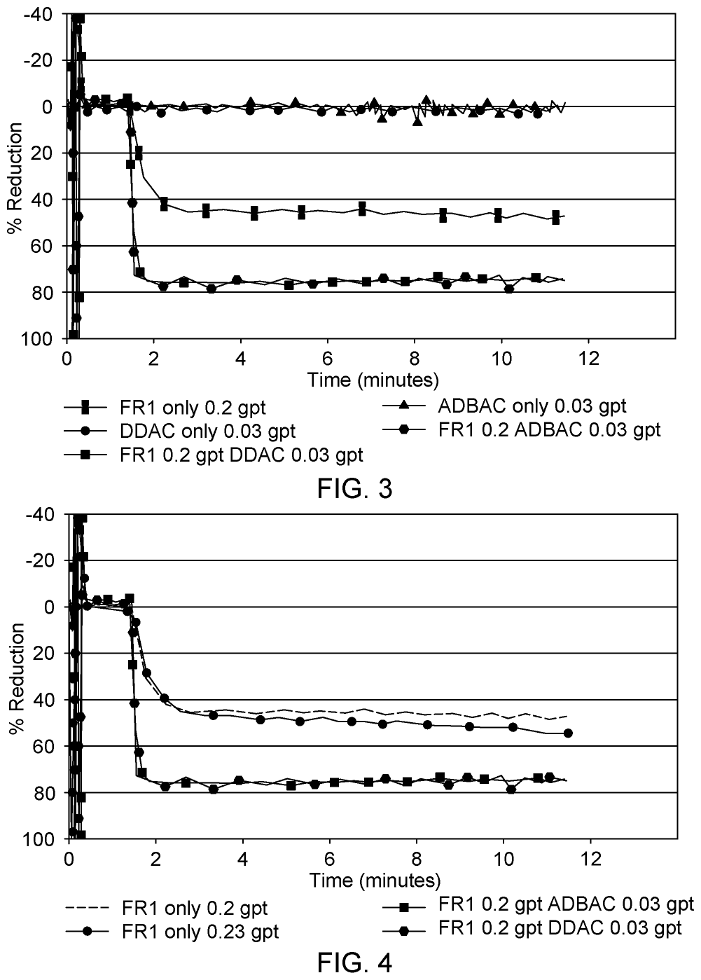

Friction reduction performance of a friction reduction booster alone and in combination with a friction reducer was tested. A flow loop was used to test the effects of adding a first anionic friction reducer FR1, alkyldimethylbenzylammonium chloride (ADBAC), and dodecyldimethylammonium chloride (DDAC) to a brine with 3000 TDS content. The fluids tested were 0.2 gpt FR1, 0.03 gpt ADBAC, 0.03 gpt DDAC, 0.2 gpt FR1 and 0.03 gpt ADBAC, and 0.2 gpt FR1 and 0.03 gpt DDAC. The results of the flow loop test are shown in FIG. 3. It was observed that friction reduction boosters alone do not exhibit any friction reduction and FR1 alone had a friction reduction of about 45%. It was further observed that the combination of FR1 and a friction reducer booster ADBAC and DDAC improved the maximum friction reduction of FR1 by about 37% at 3,000 TDS.

### Example 2

In this example, a flow loop test was performed with FR1 and the same 3000 TDS content brine. The fluids tested were 0.2 gpt FR1, 0.23 FR1, 0.2 gpt FR1 and 0.03 gpt ADBAC, and 0.2 gpt FR1 and 0.03 gpt DDAC. The results of the flow loop test are shown in FIG. 4. It was observed that FR1 alone had a friction reduction of about 45%-50%. It was further observed that the combination of FR1 and a friction reducer booster ADBAC and DDAC improved the maximum friction reduction of FR1 by about 27% at 3,000 TDS.

### Example 3

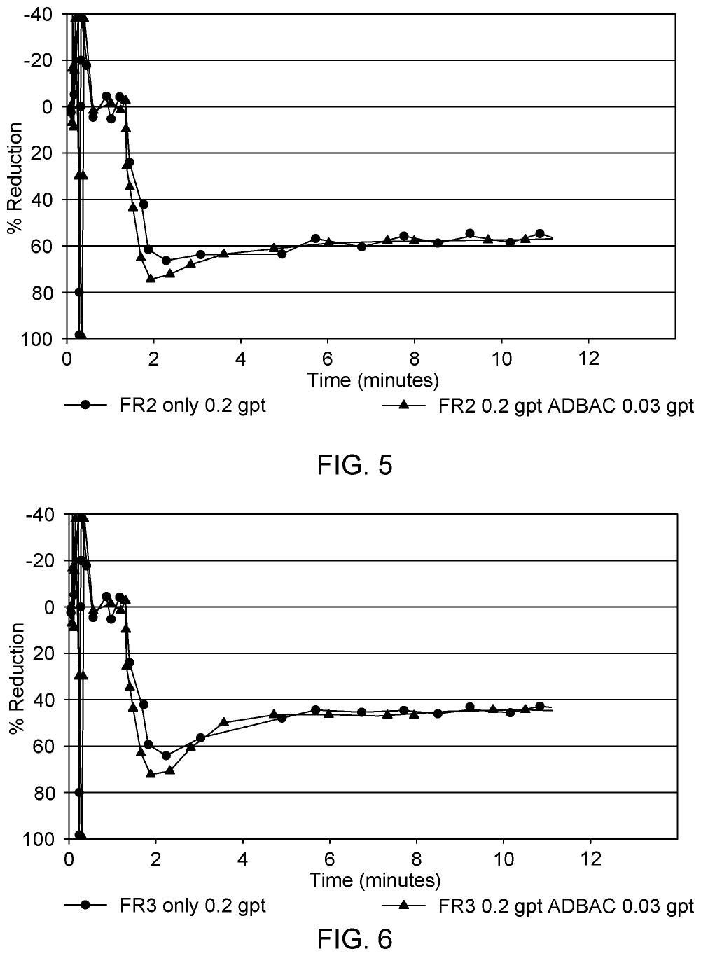

In this example, a flow loop test was performed with a second anionic friction reducer FR2 and a 20,000 TDS content brine. The fluids tested were 0.2 gpt FR2 and 0.2 gpt FR2 and 0.03 gpt ADBAC. The results of the flow loop test are shown in FIG. 5. It was observed that FR2 and a friction reducer booster ADBAC improved the maximum friction reduction of FR2 by about 17% at 20,000 TDS.

### Example 4

In this example, a flow loop test was performed with a third anionic friction reducer FR3 and a 10,000 TDS content brine. The fluids tested were 0.2 gpt FR3, and 0.2 gpt FR3 and 0.03 gpt ADBAC. The results of the flow loop test are shown in FIG. 6. It was observed that FR3 and a friction reducer booster ADBAC improved the maximum friction reduction of FR3 by about 17% at 10,000 TDS.

### Example 5

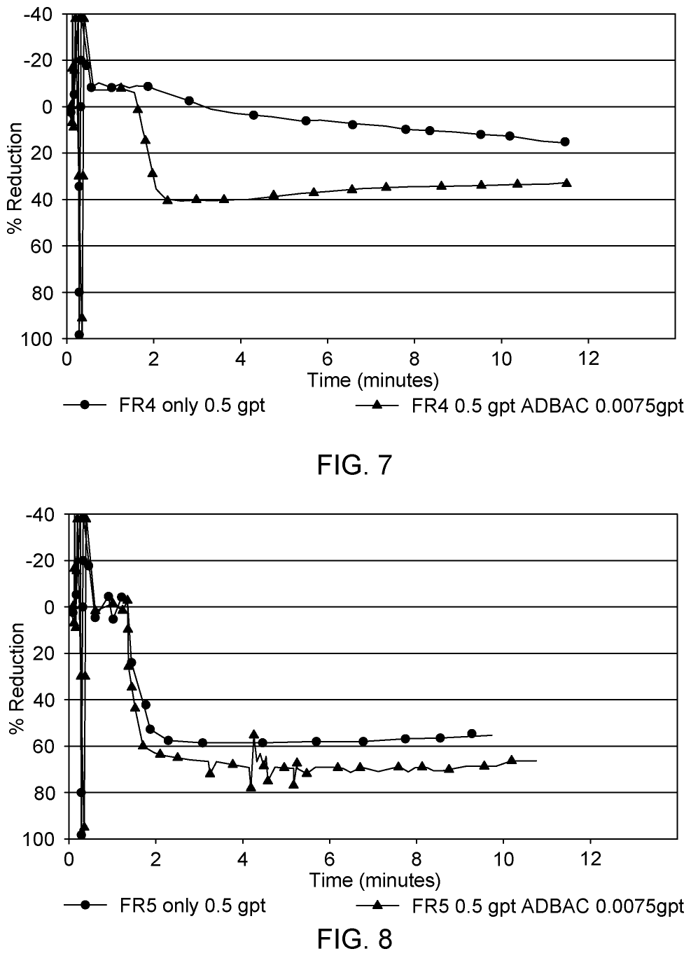

In this example, a flow loop test was performed with a fourth anionic friction reducer FR4 and a 70,000 TDS content brine. The fluids tested were 0.5 gpt FR4 and 0.5 gpt FR4 and 0.0075 gpt ADBAC. The results of the flow loop test are shown in FIG. 7. It was observed that FR4 and a friction reducer booster ADBAC improved the maximum friction reduction of FR4 by about 12% at 70,000 TDS.

### Example 6

In this example, a flow loop test was performed with a first cationic friction reducer FR5 and a 70,000 TDS content brine. The fluids tested were 0.5 gpt FR5 and 0.5 gpt FR5 and 0.0075 gpt ADBAC. The results of the flow loop test are shown in FIG. 8. It was observed that FR5 and a friction reducer booster ADBAC improved the maximum friction reduction of FR5 by about 12% at 70,000 TDS.

### Example 7

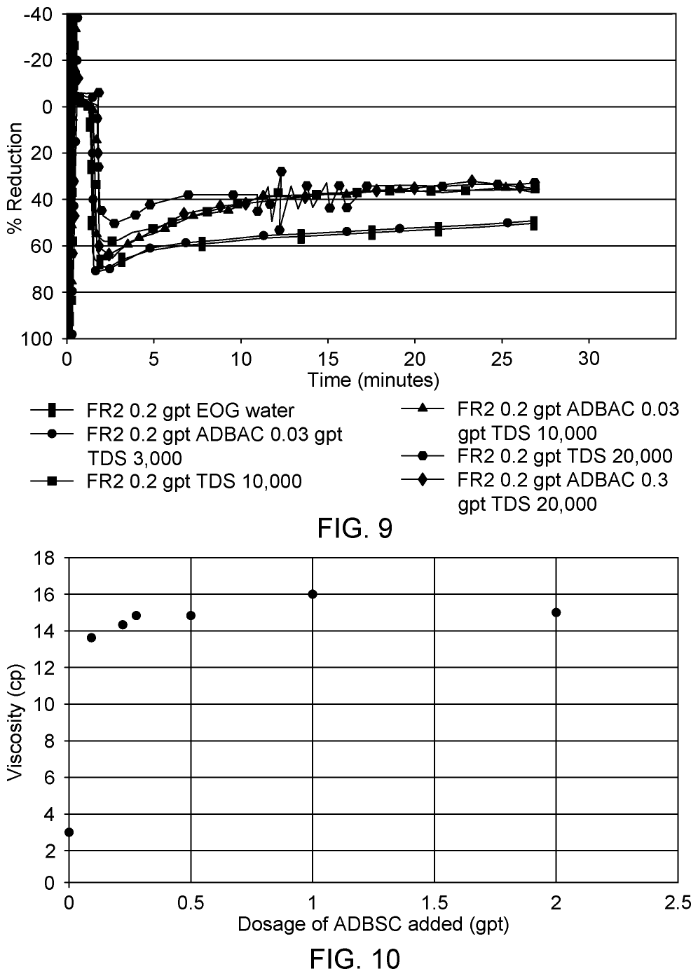

In this example, a flow loop test was performed again with the second anionic friction reducer FR2 at varying TDS content brines. The fluids tested were 0.2 gpt FR2 in 0 TDS water; 0.2 gpt FR2 and 0.03 gpt ADBAC in 3000 TDS water; 0.2 gpt FR2 in 10000 TDS water; 0.2 gpt FR2 and 0.03 gpt ADBAC in 10000 TDS water, 0.2 gpt FR2 in 20000 TDS water; and 0.2 gpt FR2 and 0.03 gpt ADBAC in 20000 TDS water. The results of the flow loop test are shown in FIG. 9. It was observed that friction reduction was improved in 6% in 3000 TDS water, 14% in 10000 TDS water, and 27% in 20000 TDS water.

### Example 8

In this example, the FR4 and friction reducer booster ADBAC were tested in sea water. The composition of the seawater is shown in Table 1. The tests were carried out in using a Fann® Instruments Fann®-35A viscometer with an R1 rotor, B1 bob, and F1 spring. Measurements were taken for 5 minutes ambient pressure and temperature at a shear rate of 511 sec⁻¹ (300 RPM). Th results of the viscosity tests are shown in Table 2. It was observed that ADBAC can increase the viscosity of FR4 in seawater at as low as 1 gpt of FR product. FIG. 10 is a graph of FR4 at 10 gpt in seawater with various dosages of ADBAC. It was observed that ADBAC could significantly increase the viscosity of FR4 at as low as 0.1 gpt addition. Further it was observed that the viscosity levels off at 0.25 gpt ADBAC.

TABLE 1

| | Concentration |
|---|---|
| Component | (mg/L) |
| Chloride | 18,980 |
| Sulfate | 2,649 |
| Bicarbonate | 140 |
| Magnesium | 1,272 |
| Calcium | 400 |
| Strontium | 13 |
| Potassium | 280 |
| Sodium | 10,556 |
| Total | 34,482 |

TABLE 2

| | Viscosity | | Viscosity |
|---|---|---|---|
| FR4 | (cp) | FR4 + ADBAC | (cp) |
| 1 gpt | 3 | 1 gpt + 0.1 gpt | 3.5 |
| 3 gpt | 3 | 3 gpt + 0.3 gpt | 5.5 |
| 5 gpt | 3 | 5 gpt + 0.5 gpt | 8 |
| 10 gpt | 3 | 10 gpt + 1 gpt | 16 |

### Example 9

In this example, another anionic friction reducer FR6 and friction reducer booster ADBAC were tested in sea water. The composition of the seawater is shown in Table 1. The same testing procedure was carried out as in Example 8. The results of the viscosity test are shown in Table 3. It was observed that ADBAC increased the viscosity of the fluid containing FR6.

TABLE 3

| | Viscosity | | Viscosity |
|---|---|---|---|
| FR6 | (cp) | FR6 + ADBAC | (cp) |
| 5 gpt | 3 | 5 gpt + 0.5 gpt | 7 |
| 10 gpt | 3 | 10 gpt + 1 gpt | 16 |

### Example 10

In this example, anionic friction reducer FR1 and friction reducer booster ADBAC were tested in sea water with the composition of Table 4. The same testing procedure was carried out as in Example 8. The results of the viscosity test are shown in Table 5. It was observed that ADBAC increased the viscosity of the fluid containing FR1.

TABLE 4

| | Concentration |
|---|---|
| Component | (mg/L) |
| Chloride | 1150 |
| Bicarbonate | 738.1 |
| Magnesium | 0.74 |
| Calcium | 2.95 |
| Iron | 0.1 |
| Barium | 0.17 |
| Strontium | 0.01 |
| Potassium | 2.82 |
| Sodium | 1016.85 |
| Total | 2911.74 |

TABLE 5

| | Viscosity | | Viscosity |
|---|---|---|---|
| FR1 | (cp) | FR1 + ADBAC | (cp) |
| 1 gpt | 3 | 1 gpt + 0.03 gpt | 4.5 |
| 2 gpt | 3.5 | 2 gpt + 0.03 gpt | 6.5 |
| 3 gpt | 5.5 | 3 gpt + 0.03 gpt | 9 |

In this example, anionic friction reducer FR4 and friction reducer booster ADBAC were tested in sea water with the composition of Table 4. The same testing procedure was carried out as in Example 8. The results of the viscosity test are shown in Table 6. It was observed that ADBAC increased the viscosity of the fluid containing FR4.

TABLE 6

| | Viscosity | | Viscosity |
|---|---|---|---|
| FR4 | (cp) | FR4 + DDAC | (cp) |
| 5 gpt | 3 | 5 gpt + 0.5 gpt | 8.5 |
| 10 gpt | 3 | 10 gpt + 1 gpt | 16.5 |

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method of fracturing a subterranean formation comprising:
providing a fracturing fluid comprising:
an aqueous base fluid,
a friction reducer, and
a friction reduction booster; and
introducing the fracturing fluid into the subterranean formation.

2. The method of claim 1, wherein the aqueous base fluid has a concentration of total dissolved solids of about 3,000 TDS to about 250,000 TDS.

3. The method of claim 2, wherein the total dissolved solids comprise at least one of chlorides, sulfates, bicarbonates, magnesium, calcium, strontium, potassium, sodium, lithium, beryllium, magnesium, calcium, strontium, iron, zinc, manganese, molybdenum, sulfur in a form of hydrogen sulfide, arsenic, barium, boron, chromium, selenium, uranium, fluorine, bromine, iodine, and combinations thereof.

4. The method of claim 1, wherein the friction reducer is a cationic friction reducer, anon-ionic friction reducer, or zwitterionic friction reducer.

5. The method of claim 1, wherein the friction reducer is selected from the group consisting of at least one of a polyacrylamide, a polyacrylamide derivative, a synthetic polymer, an acrylamide copolymer, an anionic acrylamide copolymer, a cationic acrylamide copolymer, a nonionic acrylamide copolymer, an amphoteric acrylamide copolymer, a polyacrylate, a polyacrylate derivative, a polymethacrylate, a polymethacrylate derivative, polymers synthesized from one or more monomeric units selected from the group consisting of acrylamide, acrylic acid, 2-acrylamido-2-methylpropane sulfonic acid, acrylamido tertiary butyl sulfonic acid, N,N-dimethylacrylamide, vinyl sulfonic acid, N-vinyl acetamide, N-vinyl formamide, itaconic acid, methacrylic acid, acrylic acid esters, or methacrylic acid esters, their corresponding salts related salts, their corresponding esters, or combinations thereof.

6. The method of claim 1, wherein the friction reduction booster comprises a quaternary amine with the following structure: 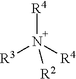
wherein R1, R2, R3, and R4 are individually selected from C1-C24 alkyl and aryl.

7. The method of claim 6, wherein the quaternary amine has the following structure: 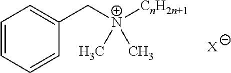
where n is any even integer from 8 to 20 and x is a halide.

8. The method of claim 1, wherein the friction reduction booster is present in a range of about 0.007 gpt to about 0.03 gpt.

9. The method of claim 1, wherein the friction reducer is present in a range of about 1 gpt to about 10 gpt.

10. The method of claim 1, wherein the fracturing fluid further comprises a proppant.

11. A fracturing fluid comprising:
an aqueous base fluid;
a friction reducer; and
a friction reduction booster.

12. The fracturing fluid of claim 11, wherein the aqueous base fluid has a concentration of total dissolved solids of about 3,000 TDS to about 250,000 TDS.

13. The fracturing fluid of claim 11, wherein the friction reducer is a cationic friction reducer, a non-ionic friction reducer, or zwitterionic friction reducer.

14. The fracturing fluid of claim 11, wherein the friction reducer is selected from the group consisting of at least one of a polyacrylamide, a polyacrylamide derivative, a synthetic polymer, an acrylamide copolymer, an anionic acrylamide copolymer, a cationic acrylamide copolymer, a nonionic acrylamide copolymer, an amphoteric acrylamide copolymer, a polyacrylate, a polyacrylate derivative, a polymethacrylate, a polymethacrylate derivative, polymers synthesized from one or more monomeric units selected from the group consisting of acrylamide, acrylic acid, 2-acrylamido-2-methylpropane sulfonic acid, acrylamido tertiary butyl sulfonic acid, N,N-dimethylacrylamide, vinyl sulfonic acid, N-vinyl acetamide, N-vinyl formamide, itaconic acid, methacrylic acid, acrylic acid esters, or methacrylic acid esters, their corresponding salts related salts, their corresponding esters, or combinations thereof.

15. The fracturing fluid of claim 11, wherein the friction reduction booster comprises a quaternary amine with the following structure: 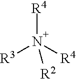
where R1, R2, R3, and R4 are individually selected from C1-C24 alkyl and aryl.

16. The fracturing fluid of claim 14, wherein the quaternary amine has the following structure: 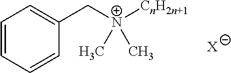
where n is any even integer from 8 to 20 and X is a halide.

17. The fracturing fluid of claim 11, wherein the friction reduction booster is present in a range of about 0.007 gpt to about 0.03 gpt.

18. The fracturing fluid of claim 11, wherein the friction reducer is present in a range of about 1 gpt to about 10 gpt.

19. The fracturing fluid of claim 11, wherein the fracturing fluid further comprises a proppant.

20. A method of fracturing a subterranean formation comprising:
providing a fracturing fluid comprising:
an aqueous base fluid, wherein the aqueous base fluid is water with a concentration of total dissolved solids of about 3,000 TDS to about 250,000 TDS,
a friction reducer, wherein the friction reducer is a polyacrylamide-containing polymer present in an amount of about 1 gpt to about 10 gpt, and
a friction reduction booster, wherein the friction reduction booster is present in an amount of about 0.007 gpt to about 0.03 gpt, and wherein the friction reduction booster comprises: 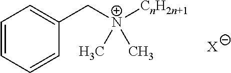
where n is any even integer from 8 to 20 and X is a halide.
and
introducing the fracturing fluid into the subterranean formation.
